(19) United States
(12) Patent Application Publication
(10) Pub. No.: US 2005/0160268 A1
(43) Pub. Date: Jul. 21, 2005

(54) Method and apparatus for data communications in a network system

(76) Inventors: Hiroyuki Chaki, Ome-shi (JP); Takashi Kokubo, Ome-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/995,144

(22) Filed: Nov. 24, 2004

(30) Foreign Application Priority Data
Nov. 28, 2003 (JP) 2003-399817

(51) Int. Cl. H04L 9/00

(52) U.S. Cl. 713/169; 726/26

(57) ABSTRACT

A network communication apparatus which transmits data to and receives it from an other device according to a network communication protocol has been disclosed. The network communication apparatus includes an authentication managing unit which switches exclusively between a transmission-side authentication process and a reception-side authentication process according to a data transmission/reception request, thereby limiting the operating time of each of the processes variably.

### CROSS-REFERENCE TO RELATED APPLICATIONS

This application is based upon and claims the benefit of priority from prior Japanese Patent Application No. 2003-399817, filed Nov. 28, 2003, the entire contents of which are incorporated herein by reference.

### BACKGROUND OF THE INVENTION

1. Field of the Invention

This invention relates to a data communication apparatus incorporated in electronic equipment connected to a network and a data communication method.

2. Description of the Related Art

In recent years, a system capable of connecting, for example, digital television equipment (hereinafter, referred to as digital TV) to, for example, a digital recorder via a network, such as a home LAN, and recording and reproducing video content simultaneously has been developed. The digital recorder is a device which generally includes a hard disk drive (HDD), a DVD (digital versatile disc) drive, and other equipment and can record the images received by the digital TV or a built-in tuner.

In such a system, when recording and reproducing are performed simultaneously, both of the digital TV and the digital recorder carry out an authentication process necessary for data transmission (hereinafter, referred to as the transmission-side authentication process for convenience sake) and an authentication process necessary for data reception (hereinafter, referred to as the reception-side authentication process for convenience sake). The authentication processes require quite a long time because they use computing processes needed to encrypt and decrypt the video content transmitted and received.

When both of the digital TV and the digital recorder are operated at the same time so as to receive their stream data (or video content data), both of the devices are required to carry out an authentication process at the same time. Moreover, in a case where a bus reset (or the process of cutting off the connection) takes place after data transmission and reception have been conducted continuously between various devices and then a reconnecting process is carried out, authentication processes might be required at the same time.

Against this backdrop, a network communication apparatus with the function of informing another device of the occurrence of a bus reset and interrupting the authentication process has been proposed (for example, refer to Jpn. Pat. Appln. KOKAI Publication No. 2002-111703).

Furthermore, there is a method of preferentially carrying out either the transmission-side authentication process or the reception-side authentication process. in this method, when the other device also preferentially carries out the authentication process, both devices can be brought into a kind of deadlock. In the field of data communications, various methods of finding a way out of the deadlock have been proposed (for example, refer to Jpn. Pat. Appln. KOKOKU Publication No. 7-9644).

By the techniques in the above prior art documents, particularly when data transmission and data reception are carried out simultaneously as in recording and reproducing, the authentication process cannot necessarily be carried out smoothly.

### BRIEF SUMMARY OF THE INVENTION

In accordance with one embodiment of the present invention, there is provided a data communication apparatus comprising: an interface which transmits data to or receives data from an external device; a connection managing unit which requests the external device to transmit or receive data; a transmission-side authentication unit which executes an authentication process for data transmission to the external device requested to receive data by the connection managing unit; a reception-side authentication unit which executes an authentication process for data reception from the external device requested to transmit data by the connection managing unit; and an authentication managing unit which exclusively switches the operation of the transmission-side authentication unit or the reception-side authentication unit according to a transmission request or a reception request made by the connection managing unit and thereby limits the operating time of each of the operations variably.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a block diagram to help explain an outward configuration of a system according to an embodiment of the present invention;

FIG. 2 is a block diagram to help explain an internal configuration of the system;

FIG. 3 is a block diagram showing the main part of a network communication apparatus related to the embodiment;

FIG. 4 is a timing chart to help explain the procedure for an authentication process related to the embodiment; and

FIG. 5 is a flowchart to help explain the procedure for an authentication management process related to the embodiment.

### DETAILED DESCRIPTION OF THE INVENTION

Hereinafter, referring to the accompanying drawings, an embodiment of the present invention will be explained.

(System Configuration)

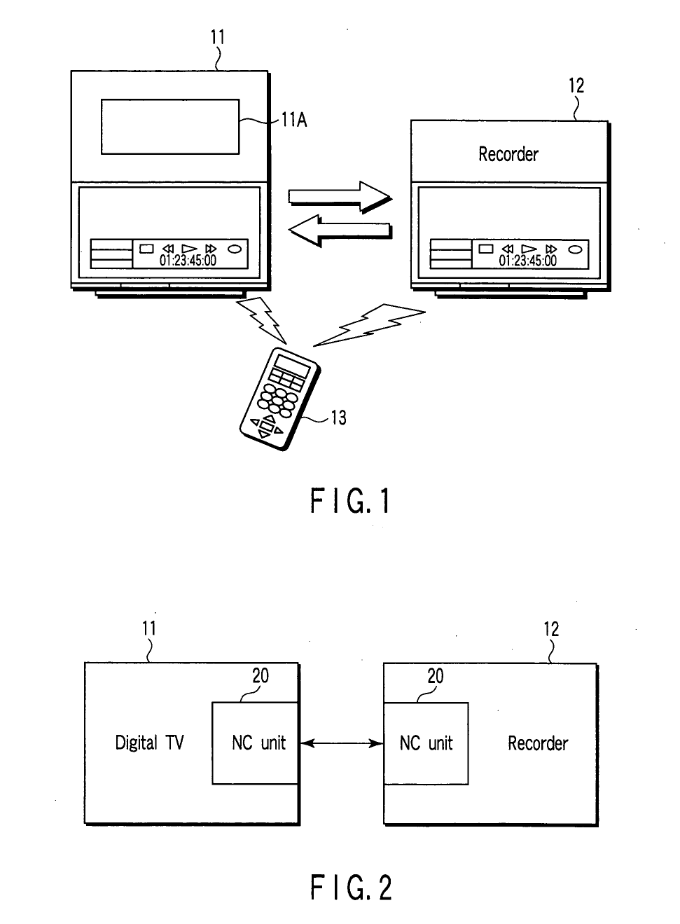

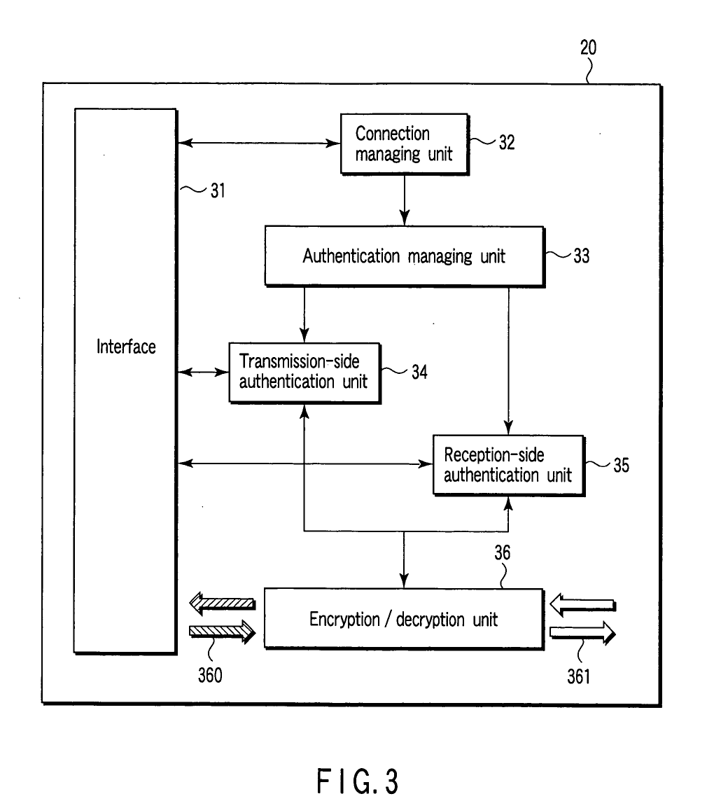

FIGS. 1 and 2 are block diagrams to help explain the configuration of a system according to an embodiment of the present invention. FIG. 3 is a block diagram showing the main part of a network communication apparatus (or data communication apparatus) 20 related to the embodiment.

In the system of the embodiment, for example, a digital TV unit 11 and a digital recorder 12 are connected to a network and transmit or receive chiefly video content data as shown in FIG. 1. The network is, for example, a home local area network (LAN) and uses a data communication protocol complying with, for example, the IEEE 1394 bus standard, universal serial bus (USB) standard, or Internet protocol (IP) standard.

The digital TV unit 11 has the function of receiving a digital broadcast or the like and reproducing and outputting the received image on a display 11A. As described above, the digital recorder 12 uses an HDD or a DVD as a recording medium and has a digital TV tuner built in, thereby recording digital broadcasts and the like.

In the system, a single remote-control device 13 operated by the user enables either the digital TV device 11 or the digital recorder 12 or both of them to be operated at the same time.

Each of the digital TV device 11 and the digital recorder 12 has a network communication apparatus 20 which is connected to a network and enables data communication.

The digital TV device 11 has the function of transmitting the received video data (or stream data) to the digital recorder 12 via the network communication apparatus 20 and of receiving the video data transmitted from the digital recorder 12 and reproducing and outputting the video data.

In contrast, the digital recorder 12 has the function of transmitting the recorded video data to the digital TV device 11 via the network communication apparatus 20 and of receiving the video data transmitted from the digital TV device 11 and recording the video data.

(Configuration of Network Communication Apparatus)

As shown in FIG. 3, the network communication apparatus 20 includes an interface 31 which is connected to a network and transmits and receive data, a connection managing unit 32, an authentication managing unit 33, a transmission-side authentication unit 34, a reception-side authentication unit 35, and an encryption/decryption unit 36.

The connection managing unit 32, authentication managing unit 33, transmission-side authentication unit 34, and reception-side authentication unit 35 are realized by a microprocessor (CPU) and a program. The interface 31 and encryption/decryption unit 36 are each realized by dedicated hardware, such as an LSI.

The connection managing unit 32 connects a logical socket by operating the transmission or reception counter in, for example, the other device. In the system of the embodiment, under the control of the remote-control device 13, the connection managing unit 32 requests the other device to transmit or receive data (or video content) via the interface 31.

The transmission-side authentication unit 34 executes an authentication process when the device operates as the transmission-side one. The reception-side authentication unit 35 executes an authentication process when the device operates as the reception-side one. The authentication managing unit 33 controls the operations of the transmission-side authentication unit 34 and the reception-side authentication unit 35, thereby carrying out an authentication process explained later. Specifically, the authentication managing unit 33 exclusively switches between the transmission-side authentication unit 34 and the reception-side authentication unit 35 according to a transmission or reception request made by the connection managing unit 32.

The encryption/decryption unit 36 carries out an encryption process of converting video data into encrypted data 360 and a decryption process of decrypting the encrypted data into the original video data 361. Moreover, the encryption/decryption unit 36 carries out the process of creating parameters and random numbers for a key exchange algorithm needed for an authentication process explained later and the process of determining the legitimacy of the authentication parameters acquired from the other device. The encryption/decryption unit 36 may be so designed that the source side (or the transmission side) and the sink side (or the reception side) can share the functions related to the authentication processes.

(Procedure for Authentication Process)

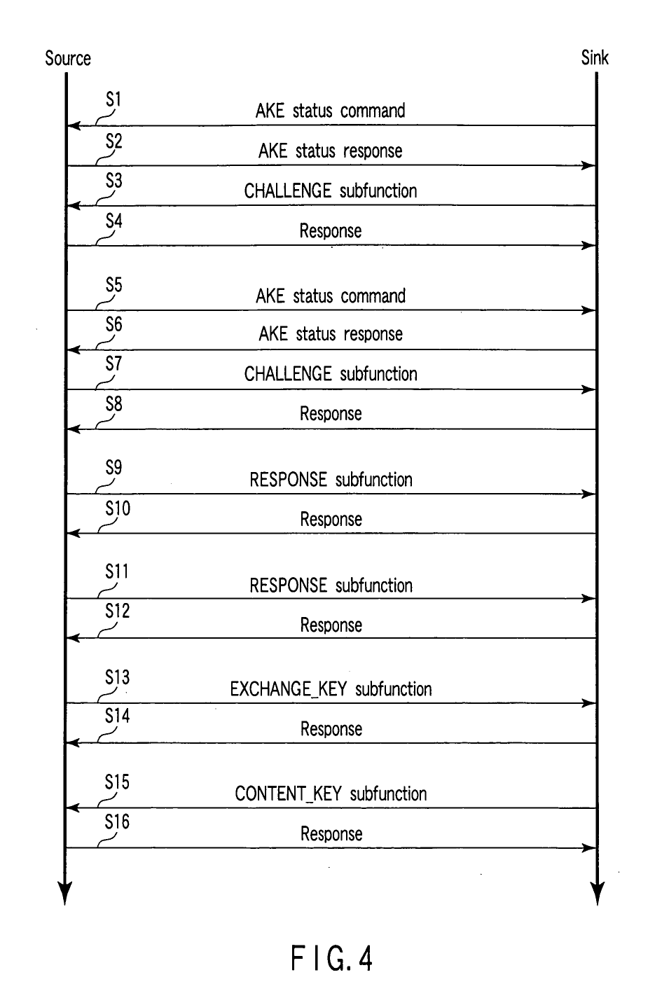

Hereinafter, the procedure for the authentication process of the network communication apparatus 20 in the embodiment will be explained by reference to a timing chart in FIG. 4.

The authentication process of the embodiment is carried out according to a procedure complying with, for example, the Digital Transmission Content Protection (DTCP) standard employed for an IEEE 1394 bus. In the DTCP standard, the key data needed for an encryption process of encrypting (or scrambling) video data is secured by an authentication key exchange (AKE) process, an authentication process.

In the AKE process, the video data transmission side is referred to as the source and the video data reception side is referred to as the sink. The AKE process is carried out by following steps S1 to S18, when one device, such as the digital recorder 12, transmits video data and the other device, such as the digital TV 11, receives the data. The AKE process begins with a command issued from the sink side (reception device). Receiving a reception request from the sink side, the source side (transmission device) starts the process.

First, the sink-side device transmits an AKE status command to the source-side device (S1). In response to this, the source-side device transfers an AKE status response (S2). This process is the process of acknowledging the status including the type of key data.

In addition, the sink-side device transfers a CHALLENGE subfunction (S3). In response to this, the source-side device transfers a response (S4). After this, an authentication process is started. Each subfunction in the AKE includes the parameters and random numbers for the aforementioned key exchange algorithm.

Then, the source-side device transfers an AKE status command to the source-side device (S5). In response to this, the sink-side device transfers an AKE status response (S6). Furthermore, the source-side device transfers a CHALLENGE subfunction (S7). In response to this, the sink-side device transfers a response (S8).

Next, the source-side device transfers a RESPONSE subfunciton (S9). In response to this, the sink-side device transfers a response (S10). Moreover, the source-side device transfers a RESPONSE subfunction (S11). In response to this, the source-side device transfers a response (S12). Then, control proceeds to the next key data exchanging process.

Specifically, the source-side device transfers an EXCHANGE_KEY subfunction (S13). In response to this, the sink-side device transfers a response (S14). Furthermore, the sink-side device further transfers a CONTENT_KEY_REQ subfunciton (S15). In response to this, the source-side device transfers both a response and key data (S16).

(Operation of Network Communication Apparatus)

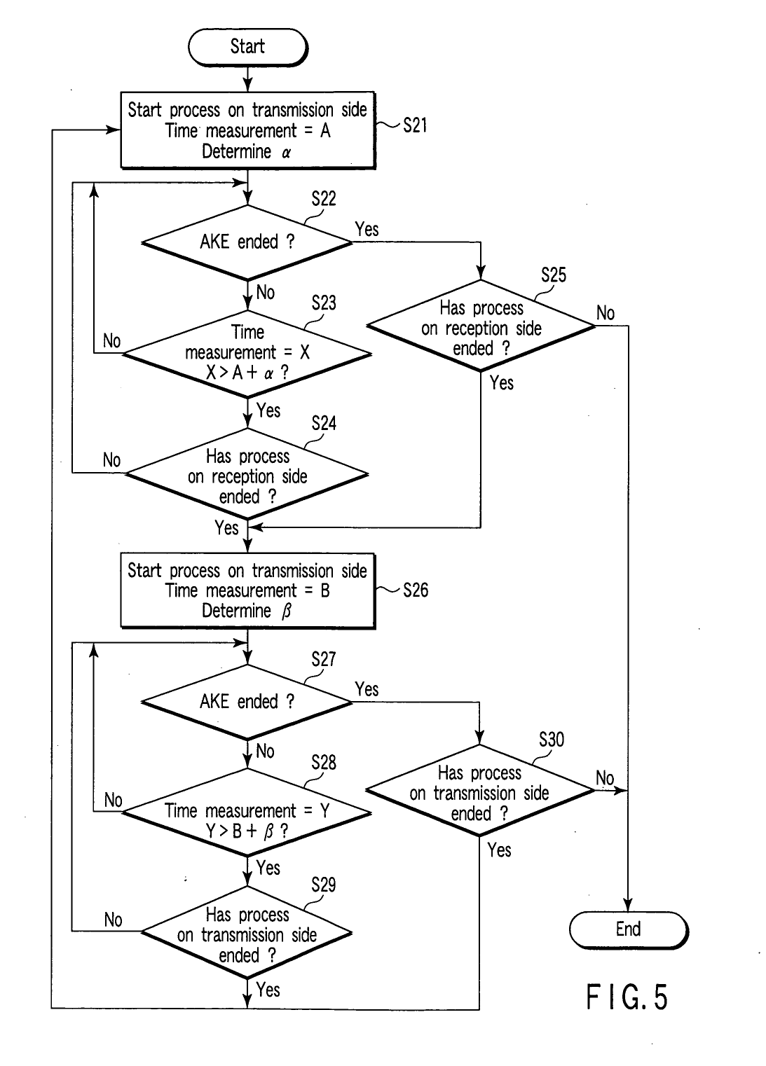

Hereinafter, referring mostly to the flowchart of FIG. 5, the operation of the network communication apparatus 20 according to the embodiment will be explained.

It is assumed that the same remote-control device 13 gives an instruction to receive video data from the other device to the digital TV 11 and digital recorder 12 connected to the network as shown in FIGS. 1 and 2. In this case, the operation related to the network communication apparatus 20 of the digital recorder 12 will be explained.

The connection managing unit 32 of the network communication apparatus 20 makes a reception request to the network communication apparatus of the digital TV 11, the other device. In contrast, the connection managing unit 32 receives a reception request from the other device 11 and executes a transmission process at the same time.

Specifically, when the transmission and reception requests have been successful, the connection managing unit 32 instructs the authentication managing unit 33 to execute a transmission-side authentication process and a reception-side authentication process. Hereinafter, the processing procedure of the authentication managing unit 33 will be explained by reference to the flowchart of FIG. 5.

The authentication managing unit 33 determines the time limit (A+α) on the basis of time measurement (the result of measurement A) in the transmission-side authentication process. The upper limit value (α) is normally set so as to include ample time for processing the aforementioned AKE sequence. In addition, the authentication managing unit 33 may determine the time limit (A+α) at random by using random numbers generated by the encryption/decryption unit 36.

The authentication managing unit 33 first causes the transmission-side authentication unit 34 to operate, thereby starting an authentication process (hereinafter, referred to as an AKE process) on the source side (or the transmission device side) (step S21). However, when the device is a recording device, such as the digital recorder 12, the authentication managing unit 33 may give priority to the operation of the reception-side authentication unit 35.

The transmission-side authentication unit 34 acquires an authentication parameter from the encryption/decryption unit 36. The transmission-side authentication unit 34 further acquires the result of the authentication and creates a subfunciton (a kind of command) and performs the source-side AKE process as shown in FIG. 4 on the other device (digital TV 11) specified by the connection managing unit 32.

The authentication managing unit 33 monitors the progress of the AKE process (step S22). If the AKE process is not completed, the authentication managing unit 33 makes a time measurement (assuming the result of measurement is X) and determines whether the predetermined time limit (A+α) has been exceeded (Yes in step S23).

If the AKE process of the transmission-side authentication unit 34 has been completed within the time limit and the AKE process of the reception-side authentication unit 35 has also been completed, the authentication managing section 33 recognizes that the transmission-side and reception-side AKE processes have been completed (No in step S23, Yes in step S22, No in step S25). Thereafter, the video data is transmitted and received, thereby encrypting the video data transmitted from the encryption/decryption unit 36 or decrypting the video data received.

On the other hand, if the AKE process has not been completed within the time limit (A+α) and the AKE process on the sink side (or the reception-device side) has not been completed, the authentication managing unit 33 stops the operation of the transmission-side authentication unit 34 (Yes in step S24).

Thereafter, the authentication managing section 33 starts the operation of the reception-side authentication unit 35 (step S26). At this time, the transmission-side authentication unit 34 responds to an already received command with a reject. At this stage, when the AKE process of the reception-side authentication unit 35 has already been completed, the authentication managing unit 33 continues the operation of the transmission-side authentication unit 34 (No in step S24).

Furthermore, if the AKE process of the transmission-side authentication unit 34 has been completed within the time limit and the AKE process of the reception-side authentication unit 35 has not been completed, the authentication managing section 33 starts the operation of the reception-side authentication unit 35 (Yes in step S25).

Before starting the operation of the reception-side authentication unit 35, the authentication managing unit 33 determines the time limit (B+β) on the basis of the time measurement (or the result of measurement B) using the same criterion as in the transmission-side authentication process.

The reception-side authentication unit 35 carries out a sink-side AKE process as shown in FIG. 4. At this time, when receiving an AKE process request from a device other than the device carrying out the AKE process, the reception-side authentication unit 35 responds to the request with a reject at the challenge stage. This enables the encryption/decryption 36 to be used exclusively.

The authentication managing unit 33 monitors the progress of the AKE process periodically (step S27). If the AKE process is not completed, the authentication managing unit 33 makes a time measurement (assuming the result of measurement is Y) and determines whether the predetermined time limit (B+β) has been exceeded (Yes in step S28).

If the AKE process of the reception-side authentication unit 35 has been completed within the time limit and the AKE process of the transmission-side authentication unit 34 has also been completed, the authentication managing section 33 recognizes that the transmission-side and reception-side AKE processes have been completed (No in step S28, Yes in step S27, No in step S30). Thereafter, the video data is transmitted and received, thereby encrypting the video data transmitted from the encryption/decryption unit 36 or decrypting the video data received.

On the other hand, if the AKE process has not been completed within the time limit (B+β) and the AKE process on the source side (or the transmission-device side) has not been completed, the authentication managing unit 33 stops the operation of the reception-side authentication unit 35 (Yes in step S29).

Thereafter, the authentication managing section 33 starts the operation of the transmission-side authentication unit 34 (step S21). At this stage, when the AKE process of the transmission-side authentication unit 34 has already been completed, the authentication managing unit 33 continues the operation of the reception-side authentication unit 35 (No in step S29).

Furthermore, if the AKE process of the reception-side authentication unit 35 has been completed within the time limit and the AKE process of the transmission-side authentication unit 34 has not been completed, the authentication managing section 33 starts the operation of the transmission-side authentication unit 34 (Yes in step S30).

As described above, with the authentication method of the embodiment, when a transmission request or a reception request is made to each of the devices 11, 12, the network communication apparatus 20 of each of the devices executes the authentication process on each of the source side (or the transmission side) and the sink side (or the reception side) in a time-shared manner. At this time, the network communication apparatus 20 sets the time limit for the processing time of each authentication process at random, which enables the occurrence of a deadlock to be avoided.

Therefore, the network communication apparatus 20 of the embodiment can carry out each authentication process smoothly, particularly when data is transmitted and received simultaneously, as in recording and reproducing.

While in the embodiment, it has been assumed that a reception request is made to the digital TV 11 and the digital recorder at the same time, a transmission request may, of course, be made at the same time. Furthermore, while in the embodiment, it has been assumed that the digital TV 11 and the digital recorder 12 are connected to a network, the present invention is not limited to this. For instance, the invention may be applied to a system where a personal computer and a digital TV are connected to a network.

Additional advantages and modifications will readily occur to those skilled in the art. Therefore, the invention in its broader aspects is not limited to the specific details and embodiment shown and described herein. Accordingly, various modifications may be made without departing from the spirit or scope of the general inventive concept as defined by the appended claims and their equivalents.

1. A data communication apparatus comprising:
an interface which transmits data to or receives data from an external device;
a connection managing unit which requests the external device to transmit or receive data;
a transmission-side authentication unit which executes an authentication process for data transmission to the external device requested to receive data by the connection managing unit;
a reception-side authentication unit which executes an authentication process for data reception from the external device requested to transmit data by the connection managing unit; and
an authentication managing unit which exclusively switches the operation of the transmission-side authentication unit or the reception-side authentication unit according to a transmission request or a reception request made by the connection managing unit and thereby limits the operating time of each of the operations variably.

2. The data communication apparatus according to claim 1, wherein, when the operation of one of the transmission-side authentication unit and the reception-side authentication unit has not ended on a preset time limit being exceeded, the authentication managing unit stops the operation of one unit and starts the operation of the other unit.

3. The data communication apparatus according to claim 1, wherein the authentication managing unit sets the time limit for each of the operations, before starting the operation of each of the transmission-side authentication unit and the reception-side authentication unit.

4. The data communication apparatus according to claim 1, wherein the authentication managing unit sets the time limit for each of the operations at random using random numbers.

5. The data communication apparatus according to claim 1, wherein the interface and the connection managing unit operate on the basis of a specified network communication protocol, and
the transmission-side authentication unit and the reception-side authentication unit execute the procedure for an authentication process on the basis of the network communication protocol.

6. A data communication method applied to a data communication apparatus which transmits data to and receives data from an external device via a data communication medium, the data communication method comprising:
starting the operation of one of a transmission-side authentication process and a reception-side authentication process according to a request for transmission to and reception from the external device;
monitoring the operating time of the transmission-side authentication process or the reception-side authentication process; and
switching the operation of one of the transmission-side authentication process and the reception-side authentication process to the operation of the other, when the operating time has exceeded a preset time limit.

7. The data communication method according to claim 6, wherein, when the operating time has exceeded the preset time limit before the completion of one of the transmission-side authentication process and the reception-side authentication process, the action of switching the operation includes stopping one process correctly in operation and starting the other of the transmission-side authentication process and the reception-side authentication process.

8. The data communication method according to claim 6, further comprising setting the time limit before starting the operation of one of the transmission-side authentication process and the reception-side authentication process.

9. The data communication method according to claim 6, further comprising setting the time limit at random using random numbers, before starting the operation of one of the transmission-side authentication process and the reception-side authentication process.

10. A network communication apparatus applied to a digital device which provides or receives services related to data transmission to and reception from an external device authenticated on the basis of a network communication protocol, the network communication apparatus comprising:
a unit which, when being requested to receive the service from and provide the service to the external device, executes the process of receiving the service and the process of providing the service in a time-shared manner;
a unit which monitors whether the processing time of each of the processes nor exceeded a preset time limit; and
a controller which exclusively switches each of the processes and gets the process done on the basis of the time limit.

11. The network communication apparatus according to claim 10, wherein, when one of the process of receiving the service and the process of providing the service has not ended or the preset time limit being exceeded, the controller stops the process and starts the other one.
